(19) United States
(12) Patent Application Publication
(10) Pub. No.: US 2007/0117894 A1
(43) Pub. Date: May 24, 2007

(54) Use of polyolefin waxes in hot melt compositions

(75) Inventors: Sebastijan Bach, Langweid (DE); Hans-Friedrich Herrmann, Grob-Gerau (DE); Gerd Hohner, Gersthofen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Produkte (Deutschland) GmbH

(21) Appl. No.: 11/601,348

(22) Filed: Nov. 17, 2006

(30) Foreign Application Priority Data
Nov. 18, 2005 (DE) 10 2005 055 018.5

(51) Int. Cl. C09D 11/02

(52) U.S. Cl. 524/270; 524/487

(57) ABSTRACT

Hot melt compositions of the type according to the invention comprise up to 40% by weight of one or more isotactic homopolymer and/or copolymer waxes comprising the monomers ethylene and/or propylene and/or higher linear or branched alpha-olefins having 4 to 20 carbon atoms, which have been prepared by polymerization of the corresponding monomers in the presence of metallocene as catalyst, and at least 60% by weight of one or more amorphous, atactic polyalpha-olefins. Hot melt compositions of this kind are suitable for use as hot melt adhesives.

The present invention is described in the German priority application No. 102005055018.5, filed 18 Nov. 2005, which is hereby incorporated by reference as is fully disclosed herein.

The invention relates to hot melt compositions based on isotactic, low molecular mass, low viscosity homopolymer or copolymer waxes and atactic polyalpha-olefins (=APAOs), up to 40% by weight of isotactic homopolymer or copolymer wax and at least 60% by weight of atactic polyalpha-olefin being present in the hot melt compositions.

Hot melt compositions or hot melts are thermoplastic materials which are solid at ambient temperature and in the liquid melt state are applied layerwise to suitable substrate surfaces where, following solidification, they exert different functions. Their composition preferably comprises resins, waxes, thermoplastics, and elastomers, and they may optionally include further additions of fillers, pigments, and additives such as stabilizers, etc.

By way of example, hot melt compositions can be used as solvent-free adhesives for bonding. On account of their multifarious advantages, hot melt adhesives of this kind are increasingly being used in the production of products including hygiene articles and care articles and also in the paper, packaging, furniture, textiles, footwear, and construction industries as an economic and eco-friendly alternative to conventional, solvent-based adhesives.

Hot melt compositions are also used in road construction as thermoplastic binders for producing visual traffic guidance marks, such as “zebra stripes” at pedestrian crossings, center lines or boundary lines, or other signal indications for controlling traffic flow. Besides waxes, the binders employed for this purpose may additionally also comprise thermoplastics, resins, and plasticizers. For roadmarking application these binders are generally blended with fillers such as sand or lime, pigments such as titanium dioxide, and light-reflecting additions, e.g., glass beads.

Constituents of typical hot melt adhesive formulas are polar and apolar polymers, resins, and waxes.

The bond strength, which derives from the remanent, post-solidification adhesiveness of a pressure sensitive hot melt adhesive, depends on the one hand on the interaction of the adhesive with the substrate to which bonding is to take place, i.e., on the adhesion between pressure sensitive hot melt adhesive and substrate; in addition, however, the bond strength is also based on the cohesion (i.e., internal strength) of the pressure sensitive hot melt adhesive itself.

The polar and apolar polymers of the pressure sensitive hot melt adhesive serve as scaffold material. They ensure the cohesion of the adhesive and at the same time contribute to adhesion to the substrate. The resin addition enhances the adhesion and may promote compatibility between the various components of the adhesive. Waxes are used for modification in fractions, based on the hot melt adhesive compositions, of generally less than 10% by weight. They regulate important physical properties of the adhesives, such as hardness, melt viscosity, and softening point, and, in their effect on open time, adhesion, cohesion, etc., they decisively influence the performance characteristics. Use of wax in amounts of more than 10% by weight has generally been found to date to be accompanied by a deterioration in the properties, particularly a reduction in the bond strength of the hot melt adhesive.

EP 890 584 describes the preparation of propylene homopolymer waxes and propylene copolymer waxes by polymerization in the presence of metallocene as catalyst, and their use in hot melt compositions, among other systems, which essentially contain three components, a polymer, an adhesive component (tackifier), and a wax.

WO 2004/104128 discloses hot melt compositions containing as polyolefin wax copolymer waxes of propylene having 0.1% to 30% by weight of ethylene, and a fraction of 0.1% to 50% by weight of a branched or unbranched 1-alkene having 4 to 20 carbon atoms.

U.S. Pat. No. 5,397,843 describes hot melt compositions comprising high molecular mass ethylene-alpha-olefin copolymers and low molecular mass atactic polyalpha-olefins (APAOs).

US 2004/0115456 and US 2004/0081795 describe hot melt compositions containing 4% to 50% by weight of isotactic propylene copolymers and 20% to 65% by weight of an adhesive component (tackifier), examples being hydrocarbon resins, natural and modified resins, resin esters, and synthetic polyterpenes, and also, optionally, atactic polyalpha-olefins (APAOs), plasticizers, wax, stabilizers, filler material, and, optionally, a secondary polymer, examples being poly(meth)acrylates, etc. The hot melt composition examples set out in the two specifications comprise isotactic propylene copolymers with 1.5% to 20% by weight of ethylene or higher alpha-olefins, the copolymers having average molar masses M_{w} of between about 170 000 and 240 000 g/mol and number-average molar masses Mₙ of between about 60 000 and 80 000 g/mol. Such high molecular mass olefin polymers are plastic-like, of high viscosity to solid, and show very little, if any, adhesion. The hot melt compositions described in US 2004/0115456 and US 2004/0081795 contain, as well as isotactic propylene copolymers, 20% to 65% by weight of a tackifier. The use of such large amounts of tackifiers can, however, lead easily to corrosion, odor, and an adverse effect on operations of recycling products provided with hot melt compositions.

Suitable processing viscosities, sufficiently good initial adhesion, cohesion, adhesion to different surface materials, low-temperature and high-temperature stability, but also a sufficient measure of flexibility, tensile load and stretching load to which composite material and adhesive bond are subjected in their specified end use, are decisive features for the quality of hot melt compositions.

It was an object of the present invention to provide novel hot melt compositions which satisfy the very different performance requirements imposed on hot melt compositions in respect of adhesion, cohesion, melt viscosity, temperature stability, etc., which at the same time can be formulated and handled well, and which can be provided economically, i.e., inexpensively and on an industrial scale.

Completely surprisingly it has been found that this object is achieved through a specific combination of isotactic, low molecular mass, low-viscosity homopolymer or copolymer waxes with atactic polyalpha-olefins (APAOs).

Mixtures of atactic polyalpha-olefins (APAOs), which have a fraction of APAOs of 60% by weight or more, with isotactic, low molecular mass, low-viscosity homopolymer or copolymer waxes have a viscosity in the range of 500 to 10 000 mPa·s, preferably between 1000 and 5000 mPa·s, measured at a temperature of 170° C., can be applied easily to surfaces and exhibit very good cohesion.

The present invention provides hot melt compositions comprising
a) 0.1% to 40% by weight, preferably 5% to 35% by weight, more preferably 10% to 30% by weight, and most preferably 20% to 25% by weight, of one or more isotactic homopolymer and/or copolymer waxes comprising the monomers ethylene and/or propylene and/or higher linear or branched alpha-olefins having 4 to 20 carbon atoms, the copolymer wax or waxes, based on the total weight of the copolymer wax or waxes, also additionally containing 0.1% to 30% by weight of structural units originating from one monomer and 70% to 99.9% by weight of structural units originating from the other monomer or monomers, and the homopolymer and copolymer wax(es) possessing a weight-average molecular weight M_{w} of less than or equal to 40 000 g/mol, and having been obtained by polymerization in the presence of metallocene as catalyst, having a dropping point or ring & ball softening point of between 80 and 165° C., possessing a melt viscosity, measured at a temperature of 170° C., of between 20 and 40 000 mPa·s, and having a glass transition temperature, T_{g}, of not more than −20° C., and
b) at least 60% by weight or more, preferably 62% to 90% by weight, more preferably 65% to 85% by weight, and most preferably 70% to 80% by weight of one or more amorphous, atactic polyalpha-olefins (APAOs).

The invention preferably provides hot melt compositions comprising
a) one or more isotactic homopolymer and/or copolymer waxes comprising the monomers ethylene and/or propylene, the copolymer waxes, based on the total weight of the copolymer waxes, containing 0.1% to 30% by weight of structural units originating from one monomer and 70% to 99.9% by weight of structural units from the other monomer, the homopolymer and copolymer waxes possessing a weight-average molecular weight M_{w} of less than or equal to 40 000 g/mol, and having been obtained by polymerization in the presence of metallocene as catalyst, having a dropping point or ring & ball softening point of between 80 and 165° C., possessing a melt viscosity, measured at a temperature of 170° C., of between 20 and 40 000 mPa·s, and having a glass transition temperature, T_{g}, of not more than −20° C., and
b) one or more amorphous, atactic polyalpha-olefins (APAOs) in the abovementioned amounts by weight.

Hot melt compositions further preferred in accordance with the invention comprise
a) one or more isotactic propylene homopolymer waxes and/or propylene copolymer waxes, the propylene copolymer waxes, based on the total weight of the copolymer waxes, containing 0.1% to 30% by weight of structural units originating from ethylene and 70% to 99.9% by weight of structural units originating from propylene, and the homopolymer and copolymer waxes possessing a weight-average molecular weight M_{w} of less than 40 000 g/mol,
b) one or more amorphous, atactic polyalpha-olefins (APAOs) in the abovementioned amounts by weight.

In a further preferred embodiment of the invention the copolymer waxes present in the hot melt compositions originate from ethylene and at least one branched or unbranched 1-alkene having 3 to 20 carbon atoms, the amount of structural units from the one or more 1-alkenes having 3 to 20 carbon atoms in the copolymer waxes being from 0.1% to 30% by weight.

Hot melt compositions further preferred in accordance with the invention comprise
a) one or more isotactic ethylene homopolymer waxes and/or ethylene copolymer waxes, the ethylene copolymer waxes, based on the total weight of the copolymer waxes, containing 70% to 99.9% by weight of structural units originating from ethylene and 0.1% to 30.0% by weight of structural units from propylene, and the homopolymer and copolymer waxes possessing a weight-average molecular weight M_{w} of less than 40 000 g/mol, and
b) one or more amorphous, atactic polyalpha-olefins (APAOs) in the abovementioned amounts by weight.

In a further preferred embodiment of the invention the polyolefin waxes present in the hot melt compositions are copolymer waxes of propylene and one or more further monomers selected from ethylene and branched or unbranched 1-alkenes having 4 to 20 carbon atoms, the content of structural units originating from ethylene in the copolymer waxes being from 0.1% to 30% by weight and the content of structural units originating from the one or more 1-alkenes having 4 to 20 carbon atoms in the copolymer waxes being from 0.1% to 50% by weight.

Hot melt compositions of the invention which are further preferred comprise homopolymer and/or copolymer waxes which have a number-average molar mass Mₙ of between 500 and 20 000 g/mol, more preferably between 800 and 10 000 g/mol, very preferably between 1000 and 5000 g/mol, and a weight-average molar mass M_{w} of between 1000 and 40 000 g/mol, more preferably between 1600 and 30 000 g/mol, and very preferably between 2000 and 25 000 g/mol.

In one preferred embodiment the hot melt compositions of the invention comprise
a) 0.1% to 39%, preferably 5% to 35%, more preferably 10% to 30%, and most preferably 20% to 25% by weight of one or more isotactic homopolymer and/or copolymer waxes comprising the monomers ethylene and/or propylene and/or higher linear or branched alpha-olefins having 4 to 20 carbon atoms, the copolymer wax or waxes, based on the total weight of the copolymer waxes, containing 0.1% to 30% by weight of structural units originating from one monomer and 70% to 99.9% by weight of structural units from the other monomer or monomers, and the homopolymer and copolymer wax(es) possessing a weight-average molecular weight M_{w} of less than or equal to 40 000 g/mol, and having been obtained by polymerization in the presence of metallocene as catalyst, having a dropping point or ring & ball softening point of between 80 and 165° C., possessing a melt viscosity, measured at a temperature of 170° C., of between 20 and 40 000 mPa·s, and having a glass transition temperature, T_{g}, of not more than −10° C., and
b) 61% to 95%, preferably 62% to 90%, more preferably 65% to 85%, and very preferably 70% to 80% by weight, of one or more amorphous, atactic polyalpha-olefins (APAOs), and
c) 0.1% to 19.9% by weight, preferably 2% to 15% by weight, more preferably 5% to 12% by weight, and most preferably 8% to 10% by weight, of a resin.

The atactic polyalpha-olefins (APAOs) used in accordance with the invention in hot melt compositions are predominantly amorphous and have a crystallinity of less than 30%, determined by DSC (differential scanning calorimetry). The APAOs employed may be homopolymers of propylene or copolymers of propylene with one or more alpha-olefins, examples being ethylene, 1-butene, 1-propene, 1-hexene, 1-heptene, and 1-octene. The weight-average molar mass M_{w} of the APAOs employed is in the range from 4000 to 150 000 g/mol, preferably between 10 000 and 100 000 g/mol. Their softening points are between 80 and 170° C., their glass transition temperatures T_{g} between −5 and −40° C.

Among the APAOs it is preferred to use propylene homopolymers, propylene-ethylene copolymers, propylene-1-butene copolymers, and propylene-ethylene-1-butene terpolymers. APAO polymers are obtainable under the trade names ®Eastoflex from Eastman Chemical Company, under the trade names ®Rextac from Huntsman Corporation or under the trade name ®Vestoplast from Degussa Corporation.

Resins available are aliphatic and cycloaliphatic hydrocarbons having softening points of 10 to 160° C., determined by ASTM method E28-58T. They may be prepared by polymerizing aliphatic and/or cycloaliphatic-olefins and diolefins. Likewise suitable are hydrogenated aliphatic and cycloaliphatic hydrocarbons from mineral oil, examples being the products obtainable from Eastman Chemical Company under the trade names Eastoflex, RegalREZ, Kristalex, Eastotac or Piccotac or from ExxonMobil Chemical Company under the name ®Escoreze.

Likewise suitable are aromatic hydrocarbons from petroleum and their hydrogenated derivatives, and also aliphatic/aromatic hydrocarbons from petroleum and their hydrogenated or acid-functionalized derivatives, aromatically modified cycloaliphatic resins and their hydrogenated derivatives, polyterpene resins having softening points between 110 and 140° C., which are prepared by polymerizing terpenes, pinene, for example, in the presence of a Friedel-Crafts catalyst, hydrogenated polyterpenes, copolymers and terpolymers of natural terpenes, examples being styrene/terpene, α-methylstyrene/terpene, and vinyltoluene/terpene. Additionally suitable are natural and modified rosins, especially resin esters, glycerol esters of tree resins, pentaerythritol esters of tree resins and tall oil resins, and their hydrogenated derivatives, and also phenol-modified pentaerythritol esters of resins, and phenol-modified terpene resins.

The hot melt compositions of the invention may further comprise polyolefin polymers, waxes, plasticizers, polar or apolar polymers, pigments, fillers, stabilizers and/or antioxidants.

The polyolefin waxes used in accordance with the invention are prepared using metallocene compounds of the formula I.

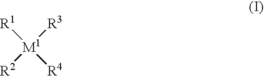

This formula also embraces compounds of the formula Ia 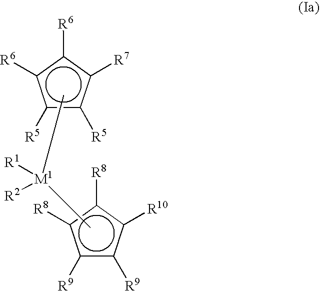
of the formula Ib 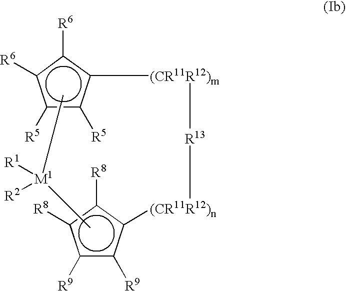
   and of the formula Ic

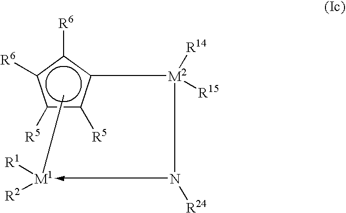

In formulae I, Ia and Ib, M¹ is a metal from group IVb, Vb or VIb of the periodic system, examples being titanium, zirconium, hafnium, vanadium, niobium, tantalum, chromium, molybdenum, and tungsten, preferably titanium, zirconium or hafnium.

R¹ and R² are identical or different and are a hydrogen atom, a C₁-C₁₀, preferably C₁-C₃ alkyl group, especially methyl, a C₁-C₁₀, preferably C₁-C₃ alkoxy group, a C₆-C₁₀, preferably C₆-C₈ aryl group, a C₆-C₁₀, preferably C₆-C₈ aryloxy group, a C₂-C₁₀, preferably C₂-C₄ alkenyl group, a C₇-C₄₀, preferably C₇-C₁₀ arylalkyl group, a C₇-C₄₀, preferably C₇-C₁₂ alkylaryl group, a C₈-C₄₀, preferably C₈-C₁₂ arylalkenyl group, or a halogen atom, preferably chlorine atom.

R³ and R⁴ are identical or different and are a mononuclear or polynuclear hydrocarbon radical which together with the central atom M¹ may form a sandwich structure. Preferably R³ and R⁴ are cyclopentadienyl, indenyl, tetrahydroindenyl, benzoindenyl or fluorenyl, it being possible for the parent structures to carry additional substituents or to be bridged with one another. It is also possible for one of the radicals R³ and R⁴ to be a substituted nitrogen atom, with R²⁴ having the definition of R¹⁷ and being preferably methyl, tert-butyl or cyclohexyl.

R⁵, R⁶, R⁷, R⁸, R⁹, and R¹⁰ are identical or different and are a hydrogen atom, a halogen atom, preferably a fluorine, chlorine or bromine atom, a C₁-C₁₀, preferably C₁-C₄ alkyl group, a C₆-C₁₀, preferably C₆-C₈ aryl group, a C₁-C₁₀, preferably C₁-C₃ alkoxy group, a radical —NR¹⁶₂—, —SR¹⁶—, —OSiR¹⁶₃—, —SiR¹⁶₃— or —PR¹⁶₂—, in which R¹⁶ is a C₁-C₁₀, preferably C₁-C₃ alkyl group or C₆-C₁₀, preferably C₆-C₈ aryl group or else, in the case of radicals containing Si or P, is a halogen atom, preferably chlorine atom, or pairs of adjacent radicals R⁵, R⁶, R⁷, R⁸, R⁹, or R¹⁰ form a ring with the carbon atoms connecting them. Particularly preferred ligands are the substituted compounds of the parent structures cyclopentadienyl, indenyl, tetrahydroindenyl, benzoindenyl or fluorenyl.

R¹³ is

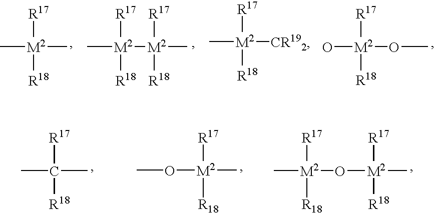

═BR¹⁷, ═AIR¹⁷, —Ge—, —Sn—, —O—, —S—, ═SO, ═SO₂, ═NR¹⁷, ═CO, ═PR¹⁷ or ═P(O)R¹⁷, R¹⁷, R¹⁸, and R¹⁹ being identical or different and being a hydrogen atom, a halogen atom, preferably a fluorine, chlorine or bromine atom, a C₁-C₃₀, preferably C₁-C₄ alkyl, especially methyl, group, a C₁-C₁₀ fluoroalkyl, preferably CF₃ group, a C₆-C₁₀ fluoroaryl, preferably pentafluorophenyl group, a C₆-C₁₀, preferably C₆-C₈ aryl group, a C₁-C₁₀, preferably C₁-C₄ alkoxy, especially methoxy group, a C₂-C₁₀, preferably C₂-C₄ alkenyl group, a C₇-C₄₀, preferably C₇-C₁₀ aralkyl group, a C₈-C₄₀, preferably C₈-C₁₂ arylalkenyl group or a C₇-C₄₀, preferably C₇-C₁₂ alkylaryl group, or R¹⁷ and R¹⁸, or R¹⁷ and R¹⁹, each form a ring together with the atoms connecting them.

M² is silicon, germanium or tin, preferably silicon and germanium. R¹³ is preferably ═CR¹⁷R⁸, ═SiR¹⁷R¹⁸, ═GeR¹⁷R¹⁸—O—, —S—, ═SO, ═PR¹⁷ or ═P(O)R¹⁷.

R¹¹ and R¹² are identical or different and have the definition stated for R¹⁷. m and n are identical or different and denote zero, 1 or 2, preferably zero or 1, with m plus n being zero, 1 or 2, preferably zero or 1.

R¹⁴ and R¹⁵ have the definition of R¹⁷ and R¹⁸.

Examples of suitable metallocenes are:

bis(1,2,3-trimethylcyclopentadienyl)zirconium dichloride,

bis(1,2,4-trimethylcyclopentadienyl)zirconium dichloride,

bis(1,2-dimethylcyclopentadienyl)zirconium dichloride,

bis(1,3-dimethylcyclopentadienyl)zirconium dichloride,

bis(1-methylindenyl)zirconium dichloride,

bis(1-n-butyl-3-methylcyclopentadienyl)zirconium dichloride,

bis(2-methyl-4,6-diisopropylindenyl)zirconium dichloride,

bis(2-methylindenyl)zirconium dichloride,

bis(4-methylindenyl)zirconium dichloride,

bis(5-methylindenyl)zirconium dichloride,

bis(alkylcyclopentadienyl)zirconium dichloride,

bis(alkylindenyl)zirconium dichloride,

bis(cyclopentadienyl)zirconium dichloride,

bis(indenyl)zirconium dichloride,

bis(methylcyclopentadienyl)zirconium dichloride,

bis(n-butylcyclopentadienyl)zirconium dichloride,

bis(octadecylcyclopentadienyl)zirconium dichloride,

bis(pentamethylcyclopentadienyl)zirconium dichloride,

bis(trimethylsilylcyclopentadienyl)zirconium dichloride,

biscyclopentadienylzirconium dibenzyl,

biscyclopentadienylzirconium dimethyl,

bistetrahydroindenylzirconium dichloride,

dimethylsilyl-9-fluorenylcyclopentadienylzirconium dichloride,

dimethylsilylbis-1-(2,3,5-trimethylcyclopentadienyl)zirconium dichloride,

dimethylsilylbis-1-(2,4-dimethylcyclopentadienyl)zirconium dichloride,

dimethylsilylbis-1-(2-methyl-4,5-benzoindenyl)zirconium dichloride,

dimethylsilylbis-1-(2-methyl-4-ethylindenyl)zirconium dichloride,

dimethylsilylbis-1-(2-methyl-4-isopropylindenyl)zirconium dichloride,

dimethylsilylbis-1-(2-methyl-4-phenylindenyl)zirconium dichloride,

dimethylsilylbis-1-(2-methylindenyl)zirconium dichloride,

dimethylsilylbis-1-(2-methyltetrahydroindenyl)zirconium dichloride,

dimethylsilylbis-1-indenylzirconium dichloride,

dimethylsilylbis-1-indenylzirconium dimethyl,

dimethylsilylbis-1-tetrahydroindenylzirconium dichloride,

diphenylmethylene-9-fluorenylcyclopentadienylzirconium dichloride,

diphenylsilylbis-1-indenylzirconium dichloride,

ethylenebis-1-(2-methyl-4,5-benzoindenyl)zirconium dichloride,

ethylenebis-1-(2-methyl-4-phenylindenyl)zirconium dichloride,

ethylenbis-1-(2-methyltetrahydroindenyl)zirconium dichloride,

ethylenebis-1-(4,7-dimethylindenyl)zirconium dichloride,

ethylenebis-1-indenylzirconium dichloride,

ethylenebis-1-tetrahydroindenylzirconium dichloride,

indenylcyclopentadienylzirconium dichloride

isopropylidene(1-indenyl)(cyclopentadienyl)zirconium dichloride,

isopropylidene(9-fluorenyl)(cyclopentadienyl)zirconium dichloride,

phenylmethylsilylbis-1-(2-methylindenyl)zirconium dichloride, and the alkyl or aryl derivatives of each of these metallocene dichlorides.

The single-center catalyst systems are activated using suitable cocatalysts. Suitable cocatalysts for metallocenes of the formula I are organoaluminum compounds, especially aluminoxanes, or else aluminum-free systems such as R²⁰ₓNH₄₋ₓBR²¹₄, R²⁰ₓPH₄₋ₓBR²¹₄, R²⁰3CBR²¹₄ or BR²¹₃. In these formulae x is a number from 1 to 4, the radicals R²⁰ are identical or different, preferably identical, and are C₁-C₁₀ alkyl or C₆-C₁₈ aryl, or two radicals R²⁰ form a ring together with the atom connecting them, and the radicals R²¹ are identical or different, preferably identical, and are C₆-C₁₈ aryl which may be substituted by alkyl, haloalkyl or fluorine. In particular R²⁰ is ethyl, propyl, butyl or phenyl and R²¹ is phenyl, pentafluorophenyl, 3,5-bistrifluoro-methylphenyl, mesityl, xylyl or tolyl.

Additionally a third component is often necessary in order to maintain protection against polar catalyst poisons. Suitable for this purpose are organoaluminum compounds such as triethylaluminum, tributylaluminum, etc., and also mixtures.

Depending on process it is also possible for supported single-center catalysts to be used. Preference is given to catalyst systems in which the residual amounts of support material and cocatalyst do not exceed a concentration of 100 ppm in the product.

The invention further provides for the use of the hot melt compositions of the invention as hot melt adhesives.

Further possible constituents are resins, waxes, and apolar or polar polymers such as, for example, ethylene-vinyl acetate copolymers, polyacrylates, polyesters, polyethers, polycarbonates, polyacetals, polyurethanes, polyolefins, and rubber polymers, such as nitrile or styrene/butadiene rubbers.

Polyisobutylene, styrene-butadiene-styrene block polymers or styrene-isoprene-styrene block polymers, and, for particularly heavy-duty bonds, polyamides or polyesters. Examples of resin components which may be present include rosins and their derivatives or hydrocarbon resins, while possible waxes are hydrocarbon waxes such as Fischer-Tropsch paraffins, and polyolefin waxes not prepared using metallocene catalysts, it being possible for said waxes to have undergone apolar or polar modification, by means, for example, of oxidation or of grafting with polar monomers such as maleic anhydride. The hot melt adhesive compositions may further comprise fillers or auxiliaries such as plasticizers, pigments, and stabilizers, such as antioxidants or light stabilizers.

The working examples which follow are intended to illustrate the invention to the person skilled in the art but are not to be understood as a restriction to specific working embodiments.

In the working examples the melt viscosities in accordance with DIN 53019 were determined using a rotational viscometer, the dropping points in accordance with DIN 51801/2, the ring & ball softening points in accordance with DIN EN 1427, and the glass transition temperatures by means of differential thermoanalysis in accordance with DIN 51700. The weight-average molar mass M_{w}, the number-average molar mass Mₙ, and the resulting quotient M_{w}/Mₙ were determined by gel permeation chromatography at 135° C. in 1,2-dichlorobenzene.

### WORKING EXAMPLES

The metallocene-polyolefin waxes 1, 2 and 3 listed in Table 1 and employed in accordance with the invention have been prepared by copolymerization of propylene with ethylene in the presence of the metallocene dimethylsilylbisindenylzirkonium-dichloride as catalyst pursuant to the general procedure described in EP 384 264 (see examples 1 to 16). The weight fraction of the monomers appears in Table 1. The differences in softening points and viscosities resulted from variations in the ethylene supply and different polymerization temperatures.

TABLE 1
Composition of polyolefin waxes

| | Ethylene | Propylene |
|---|---|---|
| Polyolefin wax | [% by weight] | [% by weight] |
| 1 | 95 | 5 |
| 2 | 90 | 10 |
| 3 | 91 | 9 |

TABLE 2
Softening/dropping point, viscosity, weight-average
molecular weights, and density of polyolefin waxes

| | | | | Weight- | |
|---|---|---|---|---|---|
| | | | | average | |
| | | Softening/ | Viscosity | molecular | |
| | | dropping | at 170° C. | weight M_{w} | Density |
| | Product type | point (° C.) | [mPa · s] | [g/mol] | [g/cm³] |
| 1 | Propylene- | 125** | 120 | 4500 | 0.89 |
| | ethylene | | | | |
| | copolymer wax | | | | |
| | (metallocene) | | | | |
| 3 | Propylene- | 90** | 400 | 6890 | 0.88 |
| | ethylene | | | | |
| | copolymer wax | | | | |
| | (metallocene) | | | | |
| 2 | Propylene- | 92** | 1600 | 13300 | 0.88 |
| | ethylene | | | | |
| | copolymer wax | | | | |
| | (metallocene) | | | | |

* Dropping point
**Softening point

Performance results:

TABLE 3
Melt viscosities and cohesions in comparison to individual components

| | | | | Cohesion | Viscosity at |
|---|---|---|---|---|---|
| 1 | 2 | 3 | Vestoplast 703 | [N/mm²] | 170° C. [mPa · s] |
| 100% by wt. | | | | *1.0 | |
| 5% by wt. | | | 95% by wt. | 2 | |
| 20% by wt. | | | 80% by wt. | 4.6 | 2130 |
| | 100% by wt. | | | *cannot be measured | |
| | 5% by wt. | | 95% by wt. | 2 | |
| | | 100% by wt. | | *1.1 | 2000 |
| | | 5% by wt. | 95% by wt. | 2 | |

*Comparison experiment

The hot melt adhesive compositions listed in Table 3 were prepared from the copolymer waxes 1, 2 and 3 indicated in Table 1, and the atactic alpha-olefins (APAOs) available under the trade name Vestoplast 703 (Degussa), with the mixing proportion being 80% or 95% by weight APAO, and 20% or 5% by weight homo- or copolymer waxes. The components were jointly melted and stirred at 180° C. for a period of 1 h.

The melt viscosities of the hot melt compositions at 170° C. were determined in accordance with DIN 53019 using a rotational viscometer; the cohesions were determined in accordance with DIN 53455 by casting moldings and testing their mechanical stability in a tensile test.

The examples show that, by adding homopolymer or copolymer waxes of 5% by weight, and particularly 20% by weight, a considerable improvement to the cohesion is achieved.

1. A hot melt composition comprising
a) 0.1% to 40% by weight of one or more isotactic homopolymer waxes, isotactic copolymer waxes or a mixture thereof, wherein the one or more waxes include the monomers ethylene, propylene, higher linear or branched alpha-olefins having 4 to 20 carbon atoms or a combination thereof, wherein the one or more waxes, based on the total weight of the one or more waxes, contain 0.1% to 30% by weight of structural units originating from one monomer and 70% to 99.9% by weight of structural units from the other monomer or monomers, wherein the one or more waxes have a weight-average molecular weight M_{w} of less than or equal to 40 000 g/mol, and are obtained by polymerization of the monomers in the presence of metallocene as catalyst, wherein the one or more waxes have a dropping point or ring & ball softening point of between 80 and 165° C., melt viscosity, measured at a temperature of 170° C., of between 20 and 40 000 mPa·s, and ha glass transition temperature, T_{g}, of not more than −20° C., and
b) at least 60% by weight of one or more amorphous, atactic polyalpha-olefins.

2. The hot melt composition as claimed in claim 1, comprising
a) one or more isotactic homopolymer waxes isotactic copolymer waxes or a mixture thereof comprising the monomers ethylene propylene or both, and
b) one or more amorphous, atactic polyalpha-olefins.

3. The hot melt composition as claimed in claim 1, comprising
a) one or more isotactic propylene homopolymer waxes, isotactic propylene copolymer waxes or a mixture thereof, and
b) one or more amorphous, atactic polyalpha-olefins.

4. The hot melt composition as claimed in claim 1, comprising
a) one or more olefin homopolymer or copolymer waxes or a mixture thereof, originating from ethylene and at least one branched or unbranched 1-alkene having 3 to 20 carbon atoms, the amount of structural units from the one or more 1-alkenes having 3 to 20 carbon atoms in the one or more waxes being from 0.1% to 30% by weight.

5. The hot melt composition as claimed in claim 1, wherein the one or more waxes have a number-average molar mass Mₙ of between 500 and 20 000 g/mol, and a weight-average molar mass M_{w} of between 1000 and 40 000 g/mol.

6. The hot melt composition as claimed in further comprising 0.1% to 19.9% by weight, of a resin.

7. The hot melt composition as claimed in claim 6, wherein the resin is a rosin and derivatives thereof or a hydrocarbon resin.

8. A hot melt adhesive comprising the hot melt composition as claimed in claim 1.

9. The hot melt composition as claimed in claim 1, wherein the one or more waxes have a number-average molar mass Mₙ of between 800 and 10 000 g/mol, and a weight-average molar mass M_{w} of between 1600 and 30 000 g/mol.

10. The hot melt composition as claimed in claim 1, wherein the one or more waxes have a number-average molar mass Mₙ of between 1000 and 5000 g/mol, and a weight-average molar mass M_{w} of between 2000 and 25 000 g/mol.

11. The hot melt composition as claimed in claim 1, further comprising 2% to 15% by weight of a resin.

12. The hot melt composition as claimed in claim 1, further comprising 5% to 12% by weight of a resin.
